(19) United States
(12) Patent Application Publication
(10) Pub. No.: US 2007/0175344 A1
(43) Pub. Date: Aug. 2, 2007

(54) Quick disconnect motor mount

(75) Inventors: Clarence A. Lewis, (US); Dina M. Lewis, Casco, ME (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Innovative Motor Controls, Casco, ME (US)

(21) Appl. No.: 11/344,867

(22) Filed: Feb. 1, 2006

(51) Int. Cl. B41F 5/00

(52) U.S. Cl. 101/216

(57) ABSTRACT

A quick disconnect motor mount for use with hand operated adjustment wheels, such as used in a printing press.

### FIELD OF THE INVENTION

The general field of the disclosed invention relates to a method of mechanically attaching motors to previously manually actuated hand wheels attached to mechanical mechanisms.

The method is ideally suited for application on newspaper printing presses where the vast majority of the installed base of newspaper printing presses are equipped with manually actuated hand wheels, for adjusting color registration.

### BACKGROUND OF THE INVENTION

The vast majority of printing presses were designed and installed before the four color printing process was introduced to the advertising industry. Since the presses were designed to print primarily black ink, the manual register mechanisms were never motorized, as the register was very crude and required only an initial setting that was not changed during the run.

With the advent of four color printing and with the demand for quality color register, the hand wheels must be adjusted frequently throughout the entire run. With the introduction of color printing, the operators' task of adjusting the many hand wheels has become very difficult, as each four color printed web has up to 16 hand wheels which are in remote locations, requiring climbing ladders and frequently walking many feet to make the adjustments. Thus, there is an urgent need to motorize the hand wheels so that the operator can make adjustments without leaving his operator control station. Additionally, with advertisers' pressure to increase the quality of color registration, automatic register controls can be justified but motors must first be installed.

### SUMMARY OF THE INVENTION

All of the attempts to add motors to existing hand wheels had classical designs that have included adding motors and gear heads mounted with brackets and/or flexible couplings, all requiring extensive modifications to the printing machine and its guards.

### OBJECTS OF THE INVENTION

Among the objects of this invention is to provide means for installing motors on existing limited-range hand wheel actuated mechanical mechanisms, such as those used in adjusting color registration on typical printing presses such as Metro, Urbanite, and Community presses, all these three newspaper printing presses manufactured by the Goss Company formerly of Chicago, Ill.

### EXEMPLARY ADVANTAGES

The following list details some of the advantages possible in some of the preferred embodiments of the present invention:
1. The motor can be removed in seconds as all that is necessary is to extract a cotter pin and remove a ¼″ pin and the motor assemble can be removed.
2. In most cases motors can be mounted directly to the hand wheel requiring only one ¾″ hole to be drilled in the guard. No other modifications to the machine are required.
3. In all other applications a ½″ drill and tapped hole is required in the 2″ thick side frame plus a ¾″ hole in the guard.
4. The guards must be removed occasionally for service and the quick disconnect feature allows rapid removal of the guards as the motors which must be removed first can be removed in seconds.
5. In case of motor failure, the motor can be removed in seconds and the hand wheel can be used as before.
6.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic drawing of a typical newspaper printing press.

FIG. 2 is a drawing of a hand wheel showing a motor attached using this invention.

### DETAILED DESCRIPTION OF THE INVENTION

A description of preferred embodiments of the invention follows.

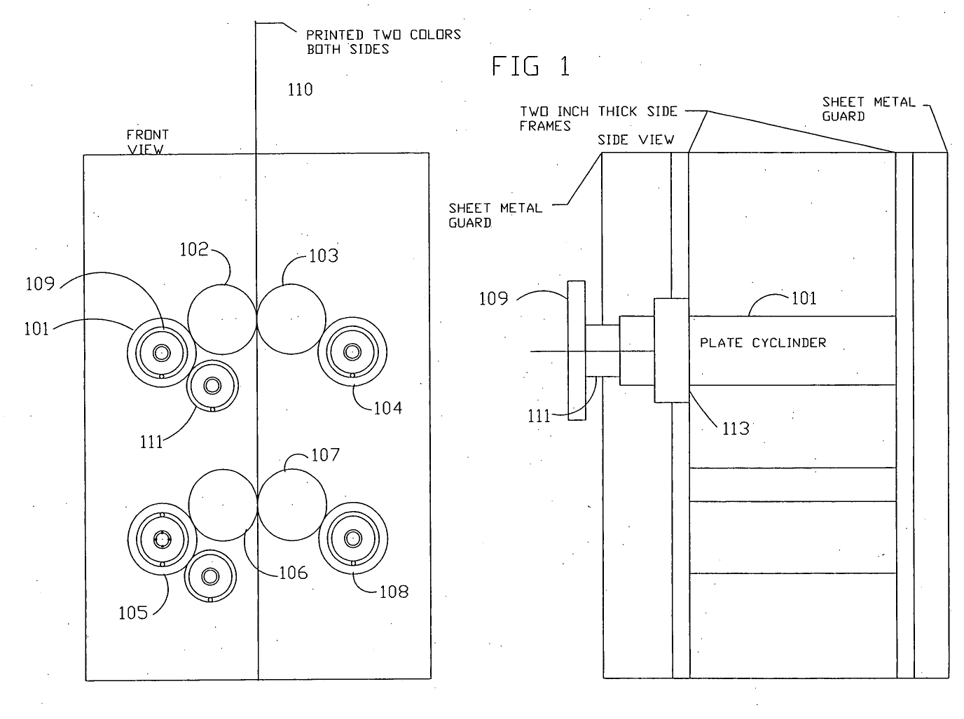

FIG. 1 shows a typical newspaper printing press similar in configuration to the Urbanite Press, manufactured by the Goss Company. It consists of printing plate cylinders 101 and 105, with corresponding blanket cylinders 102 and 106, which together print two colors on the paper 110. Plate cylinders 108 and 104, with respective blanket cylinders 103 and 107, print two colors on the other side of the paper 110.

Hand wheel 109 when turned, moves plate cylinder 101 laterally, where hand wheel 111, when turned, will move plate cylinder in the circumferential direction. Thus, between hand wheels 109 and 111, by turning these two hand wheels the operator can adjust the register of plate cylinder 101, in both the lateral and circumferential directions.

In the right-hand picture of FIG. 1 only the plate cylinder 101 is shown along with hand wheel 109 which includes threaded part 111. Both 109 and 111 are attached so that they do not move laterally however, when hand wheel 109 is turned, the internal threaded shaft within 111 (not shown) is moved laterally. This shaft is mechanically attached to the end of plate cylinder 101 so that plate cylinder 101 will also move laterally.

Hand wheel 111 is attached to plate cylinder 109 so that when it turns it will move plate cylinder 101 in the circumferential direction. The application of the invention is the same for both the lateral and circumferential hand wheels. Thus, the invention will be described only for the lateral hand wheel 101.

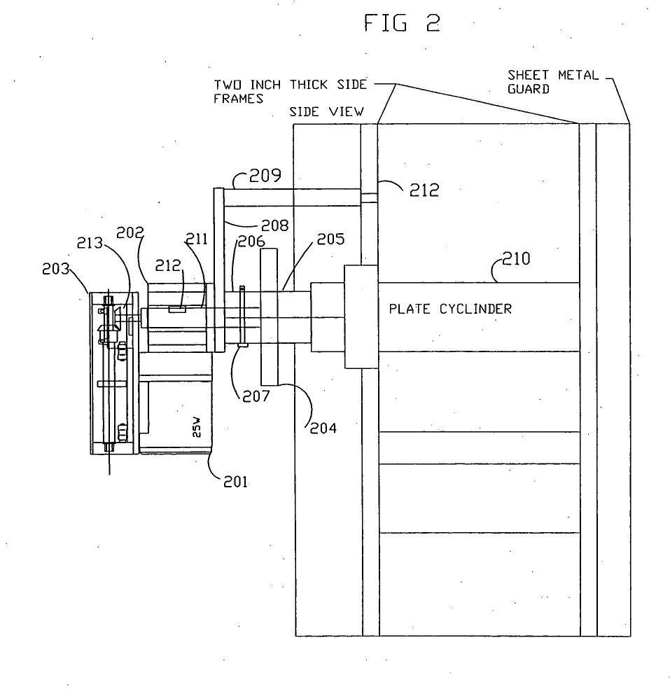

FIG. 2 shows the invention with application on hand wheel 204, which is 109 of FIG. 1. The motor 201 is attached to gearbox 202 which, through shaft 211, is attached to part 206 with pin 207. 206 is rigidly screwed and attached to 205, so that part 206 is rigidly bolted to threaded part of 205, which is 111 of FIG. 1.

Shaft 211 is keyed to the hollow shaft of gearbox 202 with key 212. Shaft 211 connects to the small miter gear 213 and runs through the hollow shaft of gearbox 202 and into 206, where it is pinned to 206 with pin 207.

Arm 208 is bolted to the frame of gearbox 202 and attached at the other end with stud 209. 209 is threaded on both ends with one end screwed into a hole drilled and tapped into side frame 212 ready to receive the threaded stud. The other end of stud 209 is attached to arm 208 with sufficient clearance to allow some misalignment.

Thus when the motor is actuated, shaft 211 turns, and as it is attached to the hand wheel via pin 207 and bracket 206, it turns hand wheel 204, moving cylinder 210 in the lateral direction. Arm 208 and stud 209 prevent the motor from rotating. Item 203 is a limit switch assembly that prevents the limited range mechanism from running into a stop. It is the subject of a co-pending patent application entitled “Restricted Motion Motor Control With Visual Indication”, serial number unknown, but filed on the same date as this application, and which is hereby incorporated by reference in its entirety.

It can be seen from the description that the motor can be mounted directly to the hand wheel and requires only one ¾″ hole to be drilled into the guard for stud 209. At most a ½″ hole must be tapped into the 2″ side frame 201 to attach the other end of the stud 209.

The motor can be removed at any time by removing the cotter key and pin 207, the motor can then be removed instantly.

This same invention is applicable to all hand wheel applications with a substantial market on the three newspaper presses Metro, Urbanite, and Community manufactured by Goss.

While this invention has been particularly shown and described with references to preferred embodiments thereof, it will be understood by those skilled in the art that various changes in form and details may be made therein without departing from the scope of the invention encompassed by the appended claims.

What is claimed is:

1. A printing press comprising:
a printing plate cylinder for printing an image;
a first hand operated adjustment wheel attached to control a lateral position of the plate cylinder;
a second hand operated adjustment wheel attached to control a circumferential position of the plate cylinder;
a motor having an attached keyed driveshaft;
removable pin means for attaching the keyed driveshaft to at last one of the first or second hand operated adjustment wheels, such that the motor can be removed by removing the pin.
